(19) United States
(12) Patent Application Publication
(10) Pub. No.: US 2002/0003875 A1
(43) Pub. Date: Jan. 10, 2002

(54) Handset housing and modular cord reel assembly

(75) Inventors: Allen Stewart, Edmonds, WA (US); Teruyoshi Nishio, Osaka (JP); Keiichi Taketani, Osaka (JP); Robert Hofmann, Evertt, WA (US); Richard Skowronski, North Hampton, NH (US)

Correspondence Address: GREER, BURNS & CRAIN, 300 S WACKER DR, 25TH FLOOR, CHICAGO, IL, 60606, US

(73) Assignee: Matasushita Avionics Systems Corporation

(21) Appl. No.: 09/876,648

(22) Filed: Jun. 7, 2001

Related U.S. Application Data
(60) Provisional application No. 60/210,217, filed on Jun. 8, 2000.

(51) Int. Cl. H04M 1/00; H04M 9/00

(52) U.S. Cl. 379/433.01; 379/455

(57) ABSTRACT

The present invention features a modular assembly for a handset, including a handset housing having a cord reel receptacle. A modular cord reel has a reel housing and a retractable cord adapted for connection to the handset. The cord reel is installed in and removable from the receptacle in the handset housing. At least one fastener removably secures the cord reel to the receptacle. Preferably the fastener is captively held in the cord reel housing to minimize dropping and loss of the fasteners.

### FIELD OF THE INVENTION

This invention relates to housings, bezels, cradles and retractable cord reels for handsets, and more specifically relates to assemblies having handset cradles and retractable cord reels, that are particularly suitable for mounting in aircraft and other vehicle seats.

### BACKGROUND OF THE INVENTION

It is known in the art to mount handsets, such as telephones, in or adjacent seats, such as aircraft and automobile seats, arm rests and consoles for the convenience of passengers. U.S. Pat. No. 5,109,412 to Hollowed et al., U.S. Pat. No. 5,128,993 to Skowronski, U.S. Pat. No. 5,155,766 to Skowronski, U.S. Pat. No. 5,410,597, to Kepley, III et al. and U.S. Pat. No. 5,507,446, to Ditzig, each of which are hereby incorporated by reference, each demonstrate a hand-held telephone useful in such locations.

It is also well known to provide a cord reel for retractably storing handset cords. Cord reels for retractably storing cords, such as telephone cords, are well known in the art. See for example U.S. Pat. No. 5,094,396 to Burke, dated March 1992, which is hereby incorporated by reference.

In the aircraft field, there are two main types of telephone cord reel assemblies in use today. A first type is an integrated unit. A housing includes a cradle for receiving a telephone handset and cord reel integrally built into the housing as shown in U.S. Pat. No. 5,155,766 to Skowronski. Damage to any part of the handset, housing or cord reel requires replacement of the entire assembly.

A second type of telephone cord reel assembly comprises a housing and cradle for the handset and separate housing for a cord reel. The cord reel is mounted within or under the seat remote from the handset, i.e., from a few inches to a few feet away from the handset cradle. If the bezel or handset is damaged, they can be readily replaced. However, if the cord reel is damaged, the seat must be opened to gain access to the cord reel for replacement.

A variation of the remote reel type has been developed for smaller aircraft, such as private jets. The cord reel is attached to the cradle housing with a bracket in a location adjacent an opening to the cradle. The retractable cord extends through the opening for connection to the handset. A plurality of screws holds the reel to the bracket, and a second plurality of screws holds the bracket to the handset housing.

A disadvantage of all of the prior art systems is the lengthy time required to replace damaged or inoperative system components. In the airline industry, it is particularly important to have the ability to quickly change-out inoperative system components. With most, if not all, prior art handset assemblies, handset maintenance is limited to Class B or higher checks under U.S. Federal Aviation Guidelines. A Class B check is typically a three hour plus maintenance check, performed by maintenance crews, typically outside of hangers at night. The maintenance crew has the ability to open seats, remove damaged or inoperative components and replace the same.

Currently it is not feasible to perform maintenance on handset assemblies during Class A checks. A Class A check is typically performed at the gate in as little time as twenty minutes. In a Class A check it not practicable to service equipment that requires opening of seats, or possibly dropping or misplacing screws.

It would be desirable to have a handset system that may be serviced quickly during a Class A check. An additional desirable feature of a handset system would be use of a fastener system that is self-contained, with no possibility of losing or misplacing parts.

### SUMMARY OF THE INVENTION

These and other objects are met or exceeded by the present invention that features a modular assembly for a handset, including a handset housing having a cord reel receptacle. A modular cord reel has a reel housing and a retractable cord adapted for connection to the handset. The cord reel is installed in and removable from the receptacle in the handset housing. At least one fastener removably secures the cord reel to the receptacle. Preferably the fastener is captively held in the cord reel housing to minimize dropping and loss of the fasteners. The housing is preferably removably installed in an airline passenger armrest or seat, and is generally recessed.

Use of the present invention provides for swift replacement of malfunctioning cord reels. Once the handset housing is removed from its installed location, the fastener holding the modular cord reel is disengaged to disconnect the fastener from the handset housing. The cord reel housing is then removed from the housing receptacle. The stationary cord to the source and the retractable cord to the handset are unplugged or otherwise disconnected. A replacement cord reel is then obtained, and the stationary cord connected to the source. A small amount or the retractable cord is pulled from the cord reel, and fed under a guide roller and through a passageway from the receptacle to a portion of the handset housing adjacent the passageway. After the stationary cord is connected to the handset, the cord reel is placed in the receptacle and reconnected to the housing with the fastener. The housing is then replaced in its installed location.

By using this invention, the ease and speed with which a cord reel can be changed allows replacement of the cord reels during a Class A maintenance check. In the preferred embodiment, use of captive fasteners also simplifies this task as the fasteners cannot be lost or misplaced during replacement of the cord reel. Each cord reel housing has self-contained fasteners that are replaced with the cord reel. Thus the lost fasteners will not delay of frustrate short maintenance procedures.

### BRIEF DESCRIPTION OF THE DRAWINGS

FIG. 1 is a perspective view of the handset, the handset housing and modular cord reel assembly of the present invention installed in the arm rest of an airline passenger seat;

FIG. 2 is a perspective view showing a handset and handset housing of the invention;

FIG. 3 is a top view of the assembly of the invention with the handset and modular cord reel installed in the housing;

FIG. 4 is a back view of the housing of the invention with the cord reel installed in the housing;

FIG. 5 is a side view of the housing of the invention with modular cord reel installed in the housing;

FIG. 6 is a back view of the handset housing of the present invention with the handset and modular cord reel removed;

FIG. 7 is a front perspective of the modular cord reel of the present invention;

FIG. 8 is a rear perspective of the modular cord reel of the present invention;

FIG. 9 is a perspective view of the cord reel being removed/installed with respect to the handset housing;

FIG. 10 is a rear perspective of the handset housing with the cord reel installed; and

FIG. 11 is a detail of a portion of the cord reel housing and the captive fastener.

### DETAILED DESCRIPTION OF THE INVENTION

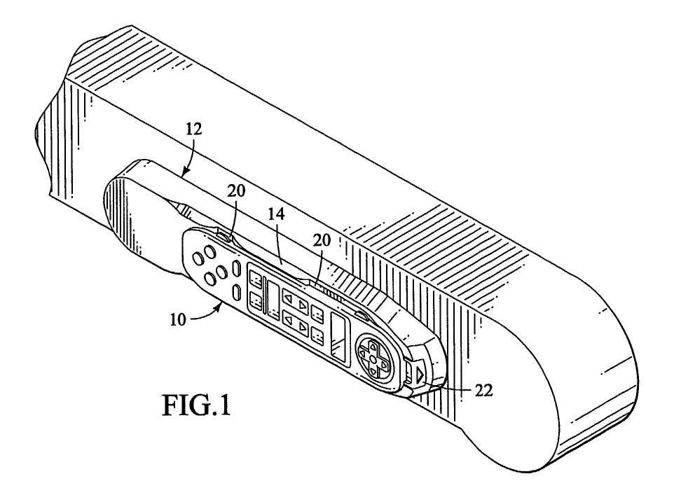

Turning now to the drawings, FIG. 1 shows a handset 10, and a housing 12. The handset may comprise a telephone handset, an entertainment system controller, a game controller, flight attendant call button, lighting and/or ventilation controls, or a combination thereof. The invention is not limited to the function of the handset.

Housing 12 is adapted to be partially recessed in an arm rest of a passenger seat, and includes a bezel 14 for that purpose. The housing 12 further comprises a plurality of fasteners 16 for fastening the bezel to the seat. It should be understood that the housing 12 may be secured to the side of an armrest, the top of an armrest, a seat back, a console between seats, a bulkhead, or any other suitable surface. The housing may be fully recessed, partially recessed, or non-recessed. Although the disclosed preferred embodiment is in reference to a handset and housing adapted to be installed in an aircraft seat, it is to be understood that the invention may be used in other environments such as automobiles and trains, and may also be used in homes, offices and other locations.

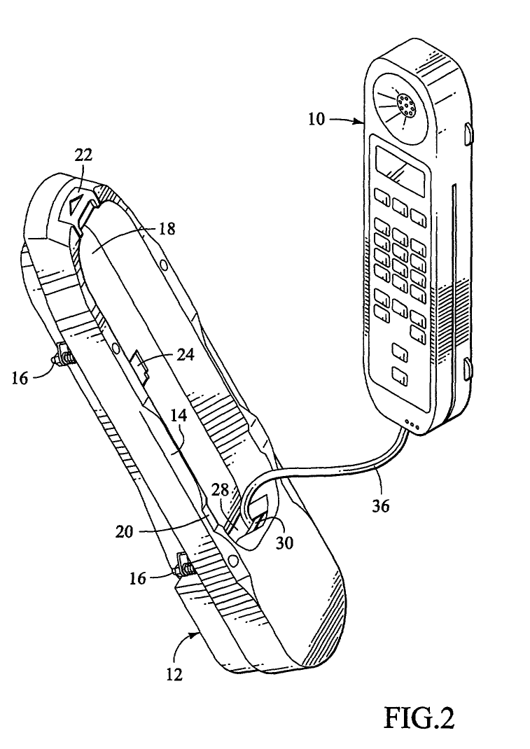

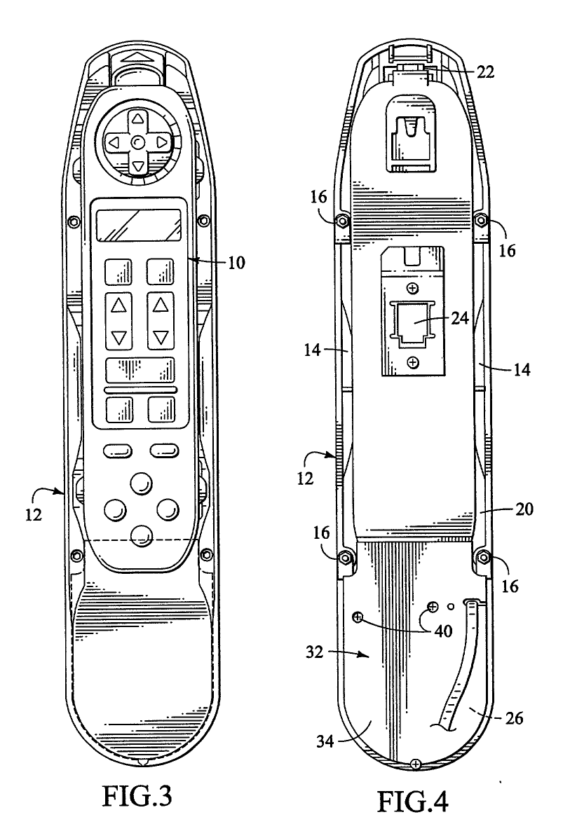

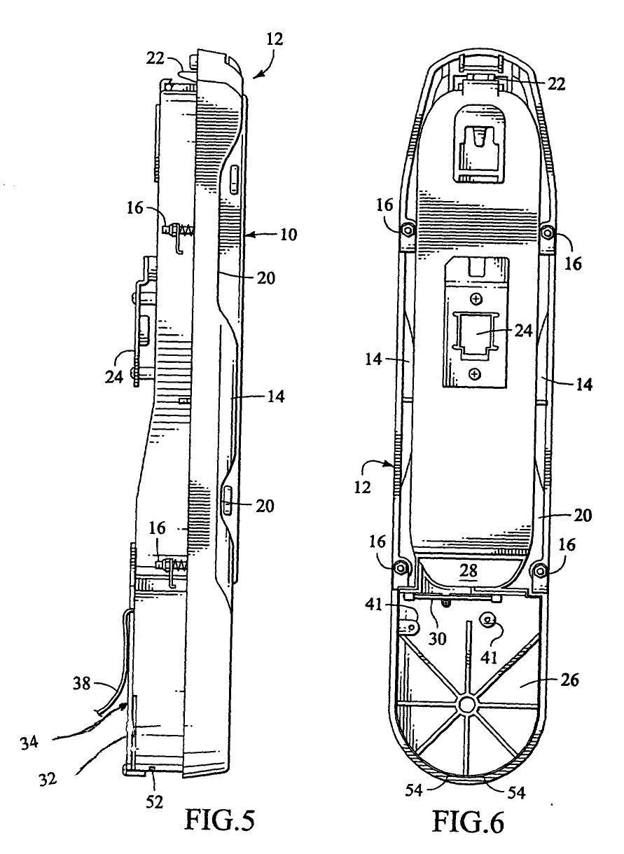

Referring to FIG. 2, the housing further includes a cradle 18 into which the handset 10 is stowed. The sides of the bezel 14 preferably include one or more cutouts 20 to facilitate gripping the handset 10. The cradle also includes a spring loaded release mechanism 22. Optionally, the housing may include one or more ports 24, such as a modem port, seen best in FIGS. 4, 5 and 6. Looking at FIG. 2, the housing 12 further comprises a cord reel receptacle 26, a passage 28 from the receptacle to the cradle 18, and a guide roller 30 adjacent the passage. The guide roller 30 may be mounted to the housing 12 in any fashion.

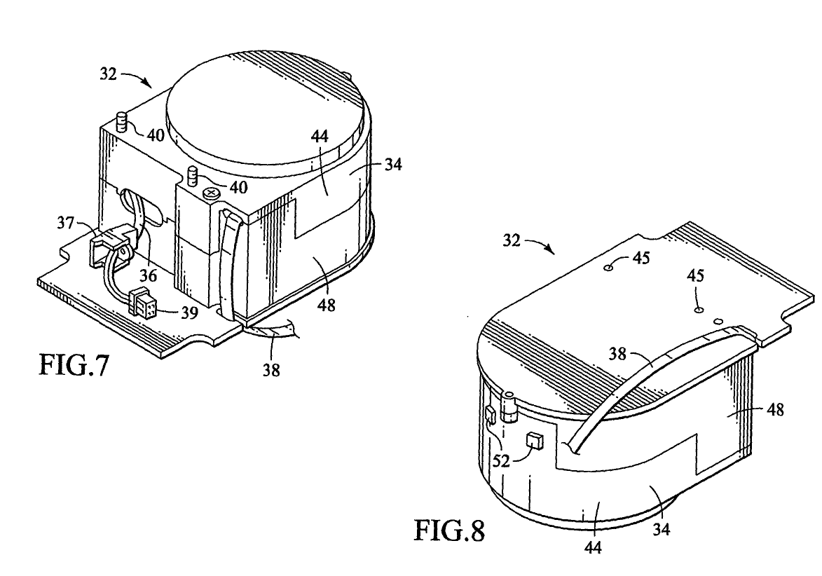

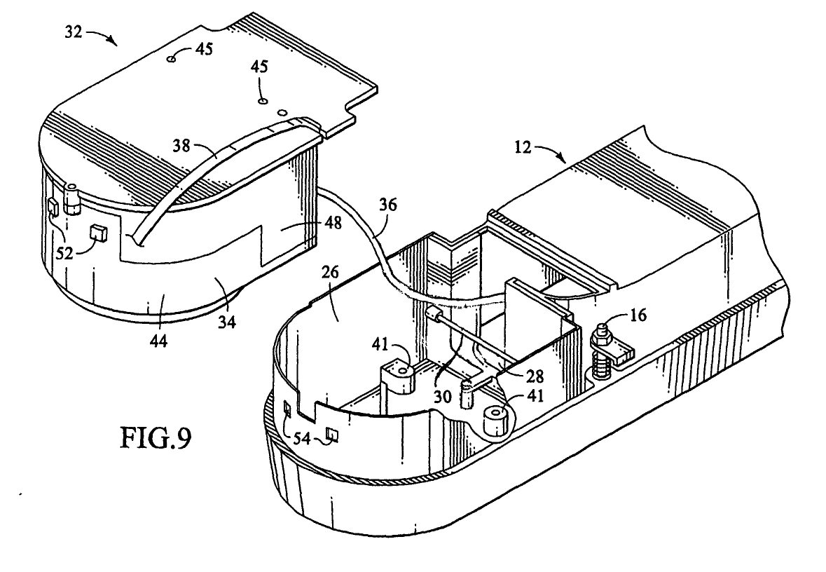

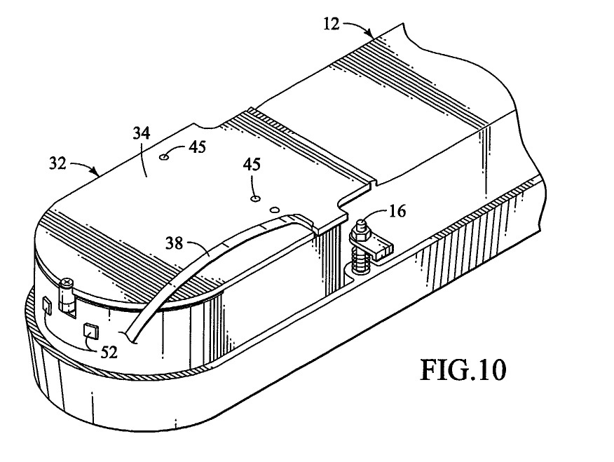

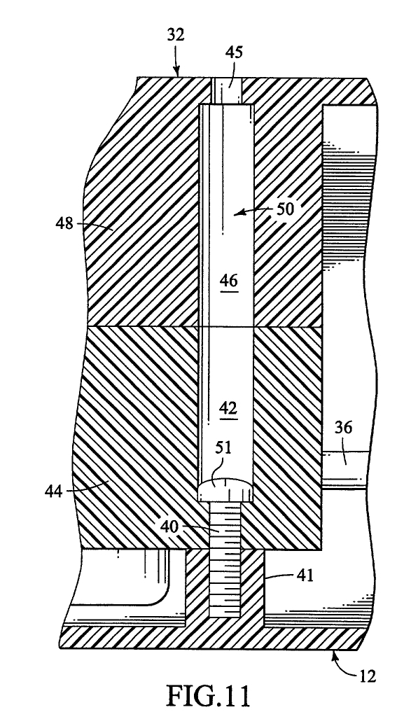

A cord reel 32 is removably secured in the receptacle 26 of the housing 12. Reel 32 is shown in detail in FIGS. 7 and 8. The cord reel comprises a housing 34, retractable cord 36 and stationary cord 38. Retractable cord 36 physically connects to the handset 10 with a grommet 37 that screws into the handset. Electrical connections are made between the retractable cords 36 and the handset 10 through plug 39. Receptacle 26 and cord reel housing 34 have complementary shapes so that reel 32 may be readily inserted and removed from housing 12. Retractable cord 36 connects to the handset 10, while the stationary cord 38 connects to a source (not shown) The source may be a telephone system, video system, in flight sound system, air craft control functions, such as lighting and call button, or any other system as may be desired. In the preferred embodiment, the receptacle 26 surrounds the reel 32 on its sides and bottom. However, it should be understood that the reel 32 and receptacle 26 may have any shape, and may enclose the reel entirely or partially. It is only necessary that the receptacle receive at least one surface of the cord reel.

The cord reel is preferably constructed in accordance with the Burke patent, U.S. Pat. No. 5,094,396, but may be constructed in other ways.

Referring now to FIG. 12, reel 32 further includes one or more fasteners 40 for securing the reel to the housing 12. Fasteners 40 are removably received in threaded holes 41 in the handset housing 12. One preferred fastener is a screw 40 captively held in reel housing 34. Specifically, housing 34 includes bore 42 in one portion 44 of the housing, bore 46 in the other housing portion 48, defining a chamber 50 between the housing portions for receiving the screw head 51. Bore 46 has an aperture 45 large enough for an installation/removal tool, but smaller than the diameter of the screw head 51. Screw 40 is inserted in bore 42 during assembly of the two housing portions 44, 48. Thereby, the screw is captively held in the housing 12.

Another fastening means is lugs 52 configured to mate with corresponding recesses or openings 54 in housing 12. Accordingly, the cord reel 32 may be quickly and easily installed or removed from the receptacle. As there are no loose screws 40 or other parts, the replacement may be made efficiently, without risk of loosing screws or other small parts. Other forms of fasteners will be apparent to those skilled in the art. It is not intended that the present application be limited to any particular form of fastening means.

The housing includes a passageway 28 connecting the cord reel receptacle 26 with the handset cradle 18. The passageway 28 for receiving retractable cord 36 is connected to handset 10. Roller 30 helps guide the retractable cord 36 into and out of the cord reel 32.

Modular construction of the unit also allows for separate manufacture of the cord reel assembly 32 and the handset housing 12. The housing 12 may be made of any suitable material, but lightweight plastics are generally preferred. The cord reel 32 is assembled as a separate unit to facilitate quick replacement of the unit during a Class A check, if needed. Completion of the modular handset cord reel assembly is accomplished by installing the cord reel into the receptacle 26 of the housing 12, and engaging the fastener 40 with the housing.

As those skilled in the art will appreciate, the modular cord reel 32 may be quickly and efficiently plugged into and removed from housing 12. If any of the components in the assembly of the invention is damaged or inoperative, one may replace the same in a few minutes. There are no small parts that may be lost or misplaced while changing out components. In aircraft applications this means that the multiple telephones and/or entertainment handset assemblies may be serviced during a Class A check.

Replacement of a malfunctioning cord reel 32 assembly begins by inserting the installation/removal tool into the bore 46 to engage the fastener 40 in a manner to cause it to disconnect from the housing 12. Once the fastener 40 is disengaged from the housing 12, the cord reel assembly 32 is removed from the receptacle 26. The retractable cord 36 must be disconnected from the handset 10 and stationary cord 38 must be disconnected from the source. When the replacement cord reel 32 is installed, the retractable cord 36 is received under a guide roller 30 and through a passageway 28 to the portion of the handset housing adjacent the passageway. The retractable cord 36 is then connected to the handset 10 and the stationary cord 38 connected to the source supply. The cord reel assembly 32 is then placed in the receptacle 26, aligning said the fastener s 40 with openings 41 in the housing 12. Insertion of the installation/removal tool into the bore 46 allows the tool to engage the fastener 40 to connect the cord reel assembly 32 to the housing 12, completing the process.

Another advantage is that the airlines (or other maintenance service) may reduce component inventory costs as compared to prior art integrated systems. In integrated handset assemblies, the entire unit needs to be replaced when only one component has been damaged. Thus, the maintenance service must stock a relatively large number of integrated units to account for all of the different types of component failure. With the modular handset assembly of the invention, a smaller inventory may be maintained for each component, thus reducing inventory costs. Cost savings may also be realized by obtaining the cord reel assembly and the handset housings from separate manufacturers or distributors.

The advantages of the disclosed invention are thus attained in an economical, practical, and facile manner. While preferred embodiments and example configurations have been shown and described, it is to be understood that various further modifications and additional configurations will be apparent to those skilled in the art. It is intended that the specific embodiments and configurations herein disclosed are illustrative of the preferred and best modes for practicing the invention, and should not be interpreted as limitations on the scope of the invention as defined by the appended claims.

What is claimed is:

1. A modular assembly for a handset comprising:
a) a handset housing for receiving the handset and said housing having a cord reel receptacle;
b) a modular cord reel having a reel housing, a retractable cord adapted for connection to the handset, said cord reel being installed in and removable from said receptacle in said handset housing, and
c) a fastener for removably securing said cord reel in said receptacle.

2. A modular assembly as in claim 1, wherein said fastener comprises a screw captively held in said reel housing.

3. The modular assembly of claim 2, wherein said screw is captively held by enclosing the head of said screw in a chamber in said reel housing.

4. The modular assembly of claim 1, wherein said fastener comprises a lug on said cord reel, and said housing further comprising a recess or opening that mates with said lug.

5. A modular assembly as in claim 1, wherein said handset housing further comprises a cradle for receiving the handset, a passageway from said receptacle to said cradle, and a guide roller attached to said handset housing adjacent said passageway, said retractable cord passing though said passage and across said guide roller.

6. A modular assembly as in claim 1, wherein said handset housing is removably installed in an airline passenger seat.

7. A modular assembly as in claim 6, wherein said housing is at least partially recessed in the airline passenger seat.

8. The modular assembly as in claim 1 wherein said receptacle and said cord reel housing have complementary shapes.

9. The modular cord reel of claim 1, wherein said cord reel further comprises one or more sides, a top and a bottom, and wherein said receptacle surrounds said cord reel on said sides and said bottom.

10. A handset housing and modular cord reel assembly comprising:
a) a handset housing having a cradle in an outer surface of said handset housing, a cord reel receptacle in a back surface of said handset housing adjacent said cradle, and a passage between said receptacle and said cradle;
b) a handset removably held in said cradle;
c) a modular cord reel having a reel housing, a retractable handset cord extending through said passage and connected to said handset, and at least one fastener carried by one of said reel housing and said handset housing for quickly removing and securing said cord reel in said receptacle.

11. The modular handset cord reel assembly of claim 10, further comprising a guide roller attached to said handset housing adjacent said passage, said retractable cord passing though said passage and across said guide roller to connect to said handset.

12. A method of assembling a modular handset cord reel assembly comprising:
a) providing a handset housing for removably holding the handset, and having a cord reel receptacle;
b) providing a modular cord reel having a reel housing, a retractable cord adapted for connection to the handset; and
c) removably installing said cord reel into said receptacle in said handset housing.

13. The method of claim 12, wherein said housing has a cradle for holding said handset, and whereas said installing step further includes feeding a retractable cord from said cord reel through a passageway from said receptacle to said cradle, and across a guide roller attached to said handset housing adjacent said passageway.

14. The method of claim 12, wherein said cord reel has at least one fastener captively held in a chamber in said reel housing, and said installing step further comprises fastening said reel housing into said handset housing.

15. A method of replacing a malfunctioning cord reel of a modular assembly with a replacement cord reel assembly comprising:
unfastening said malfunctioning cord reel from a receptacle in a handset housing, said cord reel comprising a stationary cord and a retractable cord;
removing said malfunctioning cord reel assembly from said receptacle;
disconnecting said stationary cord from a signal source;
disconnecting said retractable cord from a handset removably received in said handset housing;
feeding said retractable cord from said replacement cord reel assembly under a guide roller and through a passageway in said handset housing from said receptacle to said handset housing adjacent said passageway;
placing said replacement cord reel into said receptacle;
fastening said replacement reel to said receptacle; and
reconnecting said stationary cord of said replacement cord reel to the signal source.

16. The method of claim 15 wherein said fastener is a screw and said tool is a screwdriver.

17. The method of claim 15 wherein said fastener is captured in a chamber in said cord reel housing and further comprising steps of inserting a tool into said chamber of said malfunctioning reel to unfasten said fastener, and inserting the tool into said chamber of said replacement reel to fasten said fastener.
